(19) United States
(12) Patent Application Publication
(10) Pub. No.: US 2026/0142195 A1
(43) Pub. Date: May 21, 2026

(54) FUEL ELECTRODE OF SOLID OXIDE CELL FOR CARBON DIOXIDE CONVERSION USING Pt, Pd, AND/OR Ni CATALYST AND MANUFACTURING METHOD FOR THE SAME

(71) Applicant: KOREA INSTITUTE OF SCIENCE AND TECHNOLOGY, Seoul (KR)

(72) Inventors: Sungeun YANG, Seoul (KR); Ji-Won SON, Seoul (KR); Jiho HONG, Seoul (KR); Kyung Joong YOON, Seoul (KR); Jong Ho LEE, Seoul (KR); Ho-Il JI, Seoul (KR); Deok-Hwang KWON, Seoul (KR); Hye Jung CHANG, Seoul (KR); Byung Kook KIM, Seoul (KR)

(21) Appl. No.: 19/348,652

(22) Filed: Oct. 2, 2025

(30) Foreign Application Priority Data
Nov. 18, 2024 (KR) 10-2024-0164237

(51) Int. Cl. H01M 4/90; H01M 4/88; H01M 8/12; H01M 8/1213

(52) U.S. Cl. CPC H01M 4/9033; H01M 4/8882; H01M 8/1213; H01M 2008/1293

(57) ABSTRACT

A fuel electrode of a solid oxide cell for carbon dioxide conversion according to an embodiment of the present disclosure includes: a fuel electrode support layer; and a fuel electrode functional layer that is disposed on the fuel electrode support layer. The fuel electrode functional layer includes ceria doped with gadolinium in which at least one catalyst of Pt, Pd, and Ni is supported.

### CROSS-REFERENCE TO RELATED APPLICATION

This application claims priority to and the benefit of Korean Patent Application No. 10-2024-0164237 filed with the Korean Intellectual Property Office on Nov. 18, 2024, the entire contents of which are incorporated herein by reference.

### BACKGROUND OF THE INVENTION

### (a) Field of the Invention

An embodiment of the present disclosure relates to a fuel electrode of a solid oxide cell for carbon dioxide conversion using a Pt, Pd, and/or Ni catalyst and a manufacturing method for the same.

### (b) Description of the Related Art

Efforts for reducing emission of carbon dioxide are actively underway worldwide. In addition, so-called Carbon Capture & Utilization (CCU) technology that uses the carbon dioxide to make another raw material is being actively studied.

The CCU technology includes thermochemical, biochemical, photochemical, and electrochemical technologies. The electrochemical technology has an advantage of being able to increase selectivity of a desired product along with high efficiency.

A solid oxide cell is a representative example of the electrochemical CCU technology and electricity production, and is an energy source characterized by having high efficiency and selectivity. However, a conversion reaction (or an electrolytic reaction) of the carbon dioxide is famous for a very slow reaction, and acts as a continuous problem in improving performance of a solid oxide electrolysis cell.

### SUMMARY OF THE INVENTION

An embodiment of the present disclosure provides a fuel electrode of a solid oxide cell for carbon dioxide conversion (or carbon dioxide electrolysis) using a Pt, Pd, and/or Ni catalyst and a manufacturing method for the same. Specifically, the embodiment of the present disclosure provides a fuel electrode of a solid oxide cell for carbon dioxide conversion having improved performance by supporting a Pt and/or Pd catalyst in gadolinium-doped ceria (GDC), and a manufacturing method for the same.

A fuel electrode of a solid oxide cell for carbon dioxide conversion according to an embodiment of the present disclosure includes: a fuel electrode support layer; and a fuel electrode functional layer that is disposed on the fuel electrode support layer. The fuel electrode functional layer includes ceria doped with gadolinium in which at least one catalyst of Pt, Pd, and Ni is supported.

The catalyst may be supported in an amount of 0.1 to 5.0 atom % within the fuel electrode functional layer.

The catalyst may have an average particle diameter of 0.2 to 10 nm and may be dispersed within the fuel electrode functional layer.

The gadolinium may be included in an amount of 1 to 10 atom % within the fuel electrode functional layer.

The ceria may be included in an amount of 85.0 to 98.9 atom % within the fuel electrode functional layer.

A manufacturing method for a fuel electrode of a solid oxide cell for carbon dioxide conversion according to an embodiment of the present disclosure includes: mixing a catalyst powder including at least one of a Pt powder, a Pd powder, and a Ni powder with a ceria powder doped with gadolinium to manufacture a mixed powder; manufacturing a molded body by compressing the mixed powder; heat-treating the molded body; and forming a fuel electrode functional layer on a fuel electrode support layer using the heat-treated molded body as a raw material.

In the manufacturing of the mixed powder, the catalyst powder may be mixed in an amount of 0.1 to 5.0 atom % with respect to 100 atom % of the mixed powder.

A pressure applied to the mixed powder in the manufacturing of the molded body may be 100 to 500 MPa.

In the heat-treating of the molded body, a temperature may be increased at a temperature ramping rate of 50 to 150° C./h and heat treatment may be performed at a temperature of 1000 to 1600° C.

A solid oxide cell for carbon dioxide conversion according to an embodiment of the present disclosure includes: the fuel electrode that includes the fuel electrode support layer and the fuel electrode functional layer; an electrolyte layer that is disposed on the fuel electrode functional layer; and an air electrode that is disposed on the electrolyte layer.

According to an embodiment of the present disclosure, performance of a solid oxide cell for carbon dioxide conversion may be improved while an amount of catalyst is minimized.

According to an embodiment of the present disclosure, the catalyst may be evenly distributed within a fuel electrode functional layer to maximize reactivity.

### BRIEF DESCRIPTION OF THE DRAWINGS

FIG. 1 is a flowchart schematically illustrating a sequence of a manufacturing method for a fuel electrode according to an embodiment of the present disclosure.

FIG. 2 is a schematic diagram schematically illustrating a cross-section of a solid oxide cell for carbon dioxide conversion according to an embodiment of the present disclosure.

Each of FIG. 3 and FIG. 4 is a photograph of a fuel electrode functional layer manufactured in Embodiment 1 analyzed using a transmission electron microscope (TEM) and energy dispersion spectroscopy (EDS).

FIG. 5 is a photograph of a fuel electrode functional layer manufactured in Embodiment 2 analyzed using a transmission electron microscope (TEM) and energy dispersion spectroscopy (EDS).

Each of FIG. 6 and FIG. 7 is a photograph of a fuel electrode functional layer manufactured in Embodiment 3 analyzed using a transmission electron microscope (TEM) and energy dispersion spectroscopy (EDS).

FIG. 8 is a photograph of a fuel electrode functional layer manufactured in Embodiment 4 analyzed using a transmission electron microscope (TEM) and energy dispersion spectroscopy (EDS).

FIG. 9 is a photograph of a fuel electrode functional layer manufactured in Embodiment 5 analyzed using a transmission electron microscope (TEM) and energy dispersion spectroscopy (EDS).

FIG. 10 is a photograph of a fuel electrode functional layer manufactured in Embodiment 6 analyzed using a transmission electron microscope (TEM) and energy dispersion spectroscopy (EDS).

FIG. 11 is a graph of the fuel electrode functional layer manufactured in Embodiment 1 analyzed by X-ray photoelectron spectroscopy (XPS).

FIG. 12 is a graph of the fuel electrode functional layer manufactured in Embodiment 2 analyzed by X-ray photoelectron spectroscopy (XPS).

FIG. 13 is a graph of the fuel electrode functional layer manufactured in Embodiment 3 analyzed by X-ray photoelectron spectroscopy (XPS).

FIG. 14 is a graph of the fuel electrode functional layer manufactured in Embodiment 4 analyzed by X-ray photoelectron spectroscopy (XPS).

FIG. 15 is a graph showing a result of a performance test of the solid oxide cell for carbon dioxide conversion in Experimental Example 3.

FIG. 16 is a graph showing a result of a performance test of the solid oxide cell for carbon dioxide conversion in Experimental Example 3.

FIG. 17 is a graph showing a result of a performance test of the solid oxide cell for carbon dioxide conversion in Experimental Example 3.

FIG. 18 is a graph showing a result of a performance test of the solid oxide cell for carbon dioxide conversion in Experimental Example 3.

### DETAILED DESCRIPTION OF THE EMBODIMENTS

A technical term used herein is intended only to refer to a specific embodiment, and is not intended to limit the present disclosure. Singular forms used herein also include plural forms unless phrases clearly indicate an opposite meaning. A term “include” used in the specification specifies a specific characteristic, region, integer, step, operation, element, and/or component, and does not exclude presence or addition of another characteristic, region, integer, step, operation, element, and/or component.

Although not otherwise defined, all terms used herein, including a technical term and a scientific term, have the same meanings as those generally understood by a person of ordinary skill in the art to which the present disclosure belongs. Terms defined in a dictionary commonly used are additionally interpreted to have a meaning consistent with the relevant technical literature and the presently disclosed contents, and are not interpreted in an ideal or very formal sense unless otherwise defined.

Terms such as “first”, “second”, and “third” are used herein to describe various portions, components, regions, layers, and/or sections, but are not limited thereto. The terms are used only to distinguish one portion, component, region, layer, or section from another portion, component, region, layer, or section. Accordingly, a first portion, component, region, layer, or section described below may be referred to as a second portion, component, region, layer, or section within a scope that does not depart from a scope of the present disclosure.

Unless specifically stated otherwise, % may mean mol %, and if a unit is not separately described, a unit based on mol may be omitted.

In the present specification, the term “combination(s) thereof” included in an expression of a Markush form may mean a mixture or combination of one or more elements selected from the group consisting of the elements in the expression of the Markush form, and may mean including one or more selected from the group consisting of the elements.

Hereinafter, an embodiment of the present disclosure will be described in detail. However, this is provided as an example, the present disclosure is not limited thereto, and the present disclosure may be only defined by a scope of the claims described below.

A fuel electrode 10 of a solid oxide cell 100 for carbon dioxide conversion (or carbon dioxide electrolysis) according to an embodiment of the present disclosure may include a fuel electrode support layer 12 and a fuel electrode functional layer 11 disposed on the fuel electrode support layer 12.

The fuel electrode functional layer 11 may include ceria doped with gadolinium in which at least one catalyst of Pt, Pd, and Ni is supported (or disposed).

In an embodiment of the present disclosure, the catalyst may include at least one of Pt, Pd, and Ni. The platinum (Pt), the palladium (Pd), and the nickel (Ni) among metal catalysts may be excellent in improving performance and durability of the fuel electrode 10. The catalyst may be supported in an amount of 0.1 to 5.0 atom % within the fuel electrode functional layer 11. If too few catalysts are supported, it may be difficult to sufficiently improve performance of the fuel electrode 10 through the catalyst. If too many catalysts are supported, catalysts may aggregate together, and performance of the fuel electrode may be reduced. For example, the catalyst may be supported in an amount of 0.1 to 4.0 atom % within the fuel electrode functional layer 11. In some embodiments, the catalyst may be supported in an amount of 0.2 to 3.0 atom % within the fuel electrode functional layer 11. If two or more of Pt, Pd, and Ni are included at the same time, a ratio may be calculated based on their contents. For example, the catalyst may include one or more of Pt and Pd.

The catalyst having an average particle diameter of 0.2 to 10 nm may be dispersed within the fuel electrode functional layer 11. If the average particle diameter is too widely dispersed, it may be difficult to sufficiently obtain performance improvement by the catalyst. The average particle diameter may be obtained by analyzing the fuel electrode functional layer 11 using energy dispersion spectroscopy (EDS) or the like, obtaining a virtual circle having the same area as that of a catalyst particle, and then calculating a diameter of the circle. The average particle diameter may refer to an arithmetic average particle diameter. For example, the catalyst may have an average particle diameter of 0.2 to 8 nm.

The ceria doped with gadolinium may be represented as Gd_{0.1}Ce_{0.9}O_{1.95}(GDC), and the material may be based on ceria and may be reactive by itself. In an embodiment of the present disclosure, the reactivity thereof may be further promoted due to the catalyst.

The gadolinium (Gd) may be included in an amount of 1 to 10 atom % within the fuel electrode functional layer 11. If too little gadolinium is included, it may be difficult to obtain a sufficient reactivity promoting effect. If too much gadolinium is included, a problem of deteriorating phase stability or mechanical stability may occur. For example, the gadolinium (Gd) may be included in an amount of 3 to 10 atom % within the fuel electrode functional layer 11.

The ceria may be included in an amount of 85.0 to 98.9 atom % that is the remainder other than those of the catalyst and the gadolinium within the fuel electrode functional layer 11.

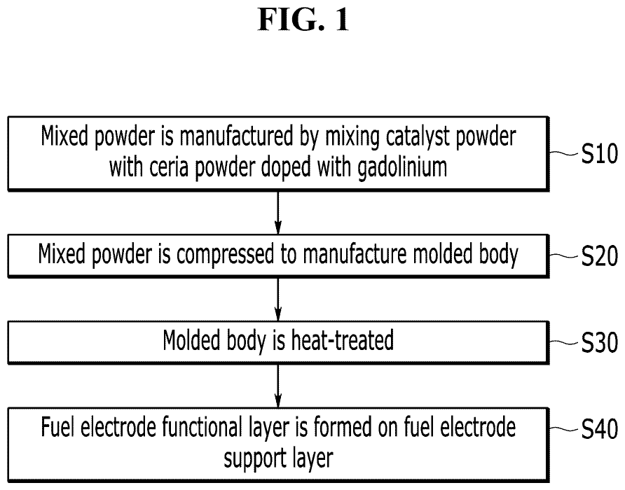

FIG. 1 shows a flowchart of a manufacturing method for a fuel electrode of a solid oxide cell for carbon dioxide conversion according to an embodiment of the present disclosure.

As shown in FIG. 1, the manufacturing method for the fuel electrode 10 of the solid oxide cell 100 for carbon dioxide conversion according to an embodiment of the present disclosure may include a step S10 of mixing a catalyst powder including at least one of a Pt powder, a Pd powder, and a Ni powder with a ceria powder doped with gadolinium to manufacture a mixed powder; a step S20 of compressing the mixed powder to manufacture a molded body; a step S30 of heat-treating the molded body; and a step S40 of forming the fuel electrode functional layer on the fuel electrode support layer using the heat-treated molded body as a raw material. The manufacturing method for the fuel electrode 10 of the solid oxide cell 100 according to the embodiment of the present disclosure may further include an additional step as necessary.

Hereinafter, each step will be described in detail.

First, in the step S10, the mixed powder may be manufactured by mixing the catalyst powder including at least one of the Pt powder, the Pd powder, and the Ni powder with the ceria powder doped with the gadolinium.

Because the catalyst powder and the ceria powder doped with the gadolinium are the same as those described above, a redundant description thereof will be omitted. In this case, the catalyst powder may be mixed at 0.1 to 5.0 atom % with respect to 100 atom % of the mixed powder.

The mixing method is not particularly limited, but a ball mill may be used.

Next, in the step S20, the mixed powder may be compressed to manufacture the molded body. A compressed shape is not particularly limited, and for example, the compressed shape may be a cylindrical shape.

A pressure applied to the mixed powder may be 100 to 500 MPa. If the pressure is too small, a shape may not be properly maintained. If the pressure is too large, there may be a problem in which a shape is not maintained and is broken. For example, the pressure applied to the mixed powder may be 150 to 300 MPa.

Next, in the step S30, the molded body may be heat-treated.

A temperature may be increased at a temperature ramping rate of 50 to 150° C./h, and heat treatment may be performed at a temperature of 1000 to 1600° C. A density of the molded body may be increased by using an appropriate temperature ramping rate and an appropriate heat treatment temperature. For example, a temperature may be increased at a temperature ramping rate of 70 to 130° C./h, and heat treatment may be performed at a temperature of 1200 to 1500° C.

Next, in the step S40, the fuel electrode functional layer may be formed on the fuel electrode support layer using the heat-treated molded body as the raw material. For examples, the fuel electrode functional layer 11 maybe formed by using the heat-treated molded body described above as a target for subsequent physical vapor deposition method on a fuel electrode support layer 12. A pulsed laser deposition (PLD) method may be used as a deposition method.

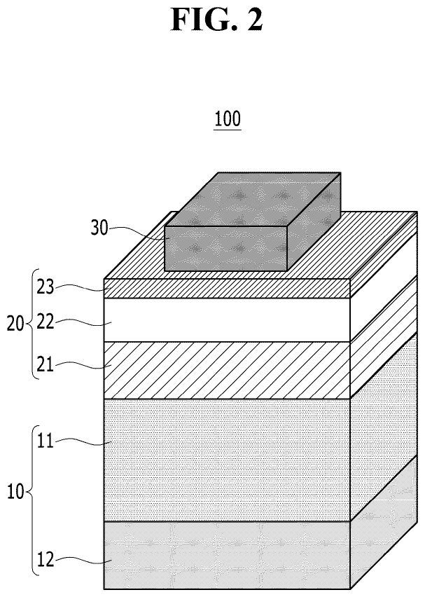

FIG. 2 schematically illustrates a cross-section of the solid oxide cell 100 for carbon dioxide conversion according to an embodiment of the present disclosure. As shown in FIG. 2, the solid oxide cell 100 for carbon dioxide conversion according to the embodiment of the present disclosure may include the fuel electrode 10 including the fuel electrode support layer 12 and the fuel electrode functional layer 11, an electrolyte layer 20 disposed on the fuel electrode functional layer, and an air electrode 30 disposed on the electrolyte layer 20.

Because the fuel electrode 10 has been described above, a detailed description thereof will be omitted. At least one of carbon monoxide and carbon dioxide may be injected into the fuel electrode 10.

The electrolyte layer 20 may include a first GDC layer 21 including ceria doped with gadolinium, a YSZ layer 22 disposed on the first GDC layer 21 and including yttria-stabilized zirconia, and a second GDC layer 23 disposed on the YSZ layer 22 and including ceria doped with gadolinium. The electrolyte layer may include a ceria-based electrolyte, a zirconia-based electrolyte, or the like used in a general SOFC without limitation. For example, the first GDC layer 21, the YSZ layer 22, and the second GDC layer 23 may be deposited using a pulsed laser deposition (PLD) method.

The air electrode 30 may include lanthanum strontium cobalt oxide (LSC). The air electrode 30 may be deposited using a pulsed laser deposition (PLD) method. The air is injected to the air electrode 30. A component of the air electrode may be selected from a lanthanum strontium-based air electrode used in a general SOFC and various air electrodes.

Hereinafter, an embodiment of the present disclosure will be described in detail. However, this is provided as an example, the present disclosure is not limited thereto, and the present disclosure may be only defined by a scope of the claims described below.

### Embodiment 1: Manufacturing of 0.3 Pt-GDC Fuel Electrode

A Pt powder is measured to be 0.3 at % of a total powder, is put together with a GDC powder, and then they are evenly mixed by ball milling.

The powder is formed into a wide cylindrical shape through pelletizing, a certain amount of load is applied with an uniaxial press, and then it is compressed at a pressure of about 200 MPa using a cold isostatic press.

Thereafter, a temperature is raised to 1400° C. at a temperature ramping rate of 100° C./h, and then heat treatment is performed for 1 hour.

A heat-treated molded body is deposited on the fuel electrode support layer using a pulsed laser deposition method at a temperature of a substrate of 700° C. in an O₂ atmosphere of 200 mTorr for 1 hour and 15 minutes to manufacture the fuel electrode functional layer.

### Embodiment 2: Manufacturing of 2.5Pt-GDC Fuel Electrode

Embodiment 2 is manufactured in the same manner as that of Embodiment 1, but a Pt powder is added to include 2.5 at %.

### Embodiment 3: Manufacturing of 0.3Pd-GDC Fuel Electrode

Embodiment 3 is manufactured in the same manner as that of Embodiment 1, but a Pd powder is added to include 0.3 at %.

### Embodiment 4: Manufacturing of 2.5Pd-GDC Fuel Electrode

Embodiment 4 is manufactured in the same manner as that of Embodiment 1, but a Pd powder is added to include 2.5 at %.

### Embodiment 5: Manufacturing of 0.3Ni-GDC Fuel Electrode

Embodiment 5 is manufactured in the same manner as that of Embodiment 1, but a Ni powder is added to include 0.3 at %.

### Embodiment 6: Manufacturing of 2.5Ni-GDC Fuel Electrode

Embodiment 6 is manufactured in the same manner as that of Embodiment 1, but a Ni powder is added to include 2.5 at %.

### Comparative Example 1: Manufacturing of Pure GDC Fuel Electrode

Comparative Example 1 is manufactured in the same manner as that of Embodiment 1, but a Pt powder is not added.

### Experimental Example 1: TEM and EDS Analysis

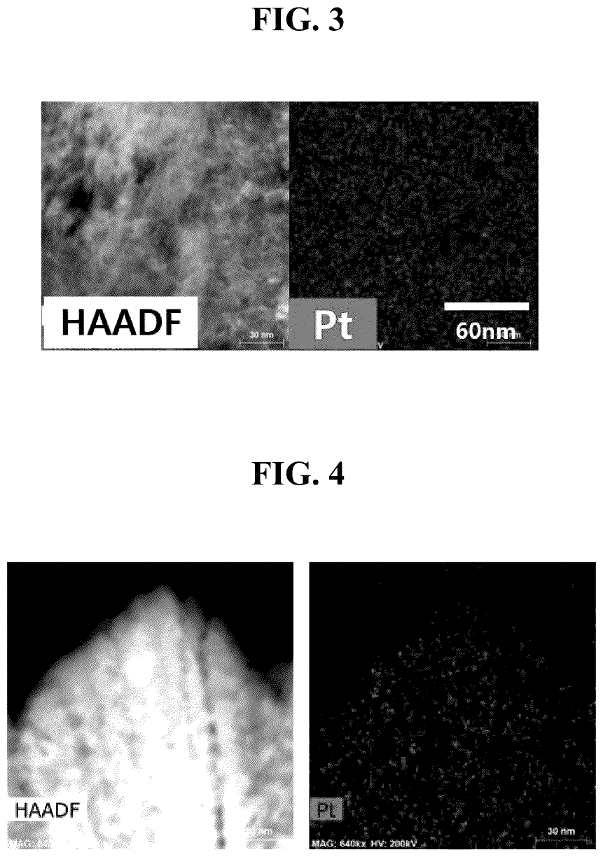

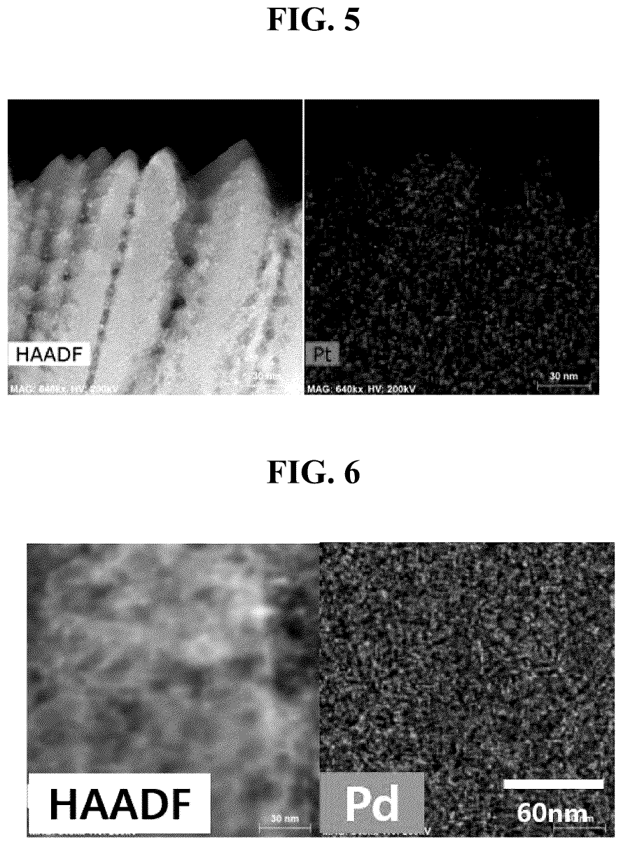

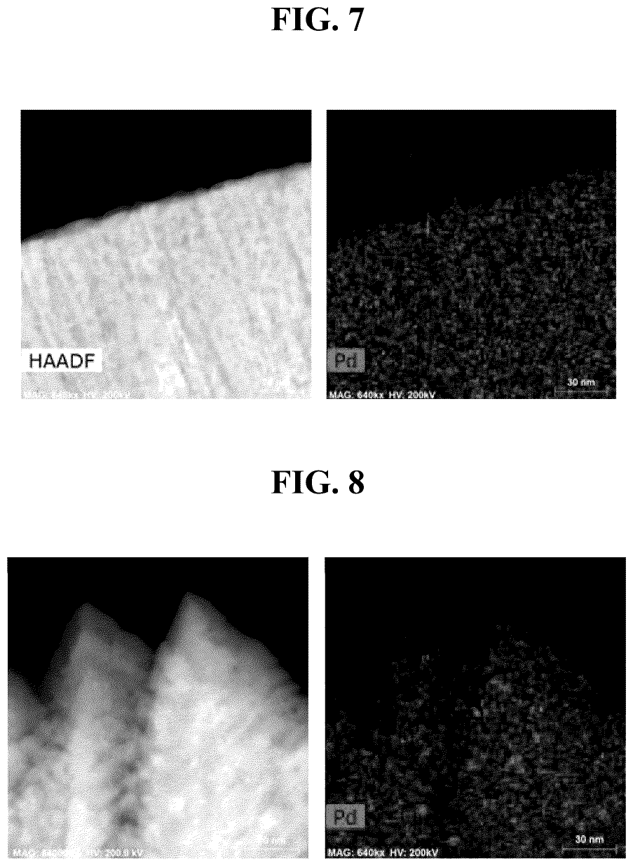

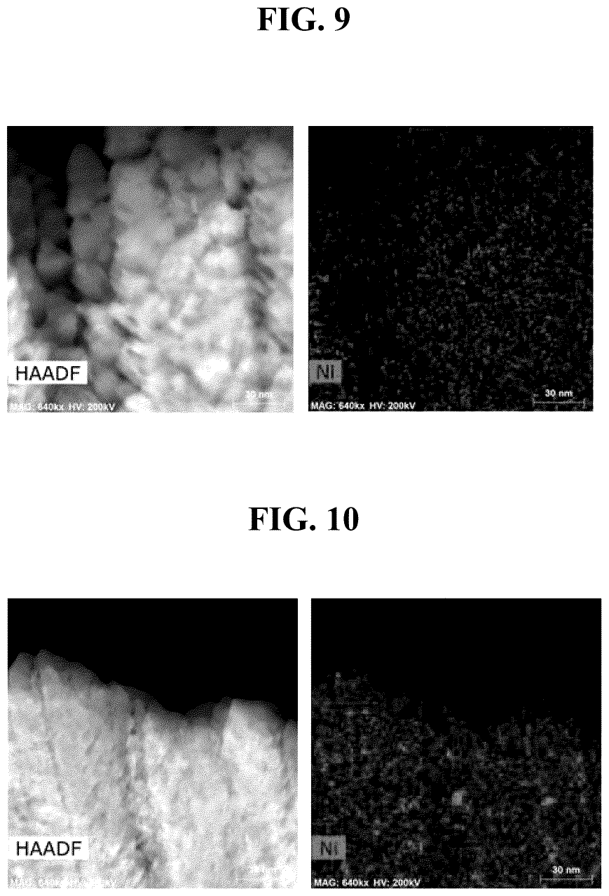

The fuel electrodes manufactured in Embodiments 1 to 6 are analyzed using a transmission electron microscope (TEM) and Energy dispersive X-ray Spectroscopy (EDS), and results of the analysis are shown in FIGS. 3 to 10.

Table 1 below summarizes contents of a catalyst, Gd, and ceria within the fuel electrodes manufactured in Embodiments 1 to 6. As shown in FIGS. 3 to 10, it may be confirmed that each of Pt, Pd, and Ni is dispersed into several nm to be uniformly distributed.

TABLE 1

| | | Content of | Content of | |
|---|---|---|---|---|
| | Naming | catalyst (at %) | Gd (at %) | Content of ceria |
| Embodiment | 0.3Pt- | 0.38 | 5.91 | The balance (or |
| 1 | GDC | | | the remainder) |
| Embodiment | 2.5Pt- | 1.74 | 4.54 | The balance |
| 2 | GDC | | | |
| Embodiment | 0.3Pd- | 0.24 | 5.03 | The balance |
| 3 | GDC | | | |
| Embodiment | 2.5Pd- | 1.82 | 4.59 | The balance |
| 4 | GDC | | | |
| Embodiment | 0.3Ni- | 0.28 | 4.16 | The balance |
| 5 | GDC | | | |
| Embodiment | 2.5Ni- | 3.11 | 5.05 | The balance |
| 6 | GDC | | | |

### Experimental Example 2: Analysis by X-Ray Photoelectron Spectroscopy (XPS)

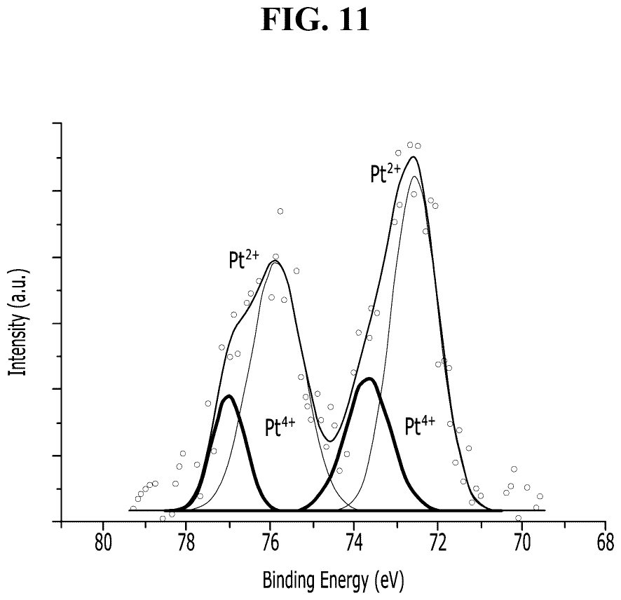

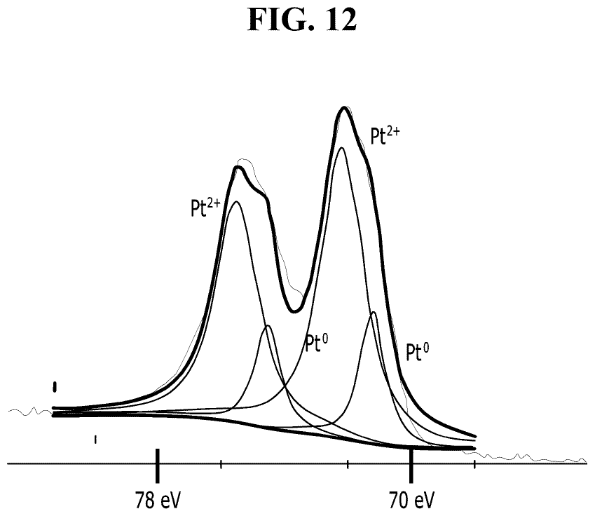

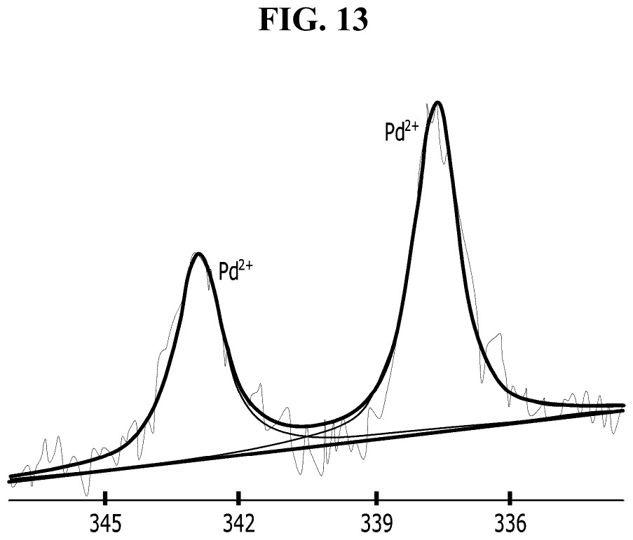

The fuel electrodes manufactured in Embodiments 1 to 4 are reduced at 600° C. for 2 hours in a 4% H₂/Ar atmosphere and then the catalyst is analyzed by the X-ray photoelectron spectroscopy (XPS) so that a result of the analysis is shown in FIGS. 11 to 14.

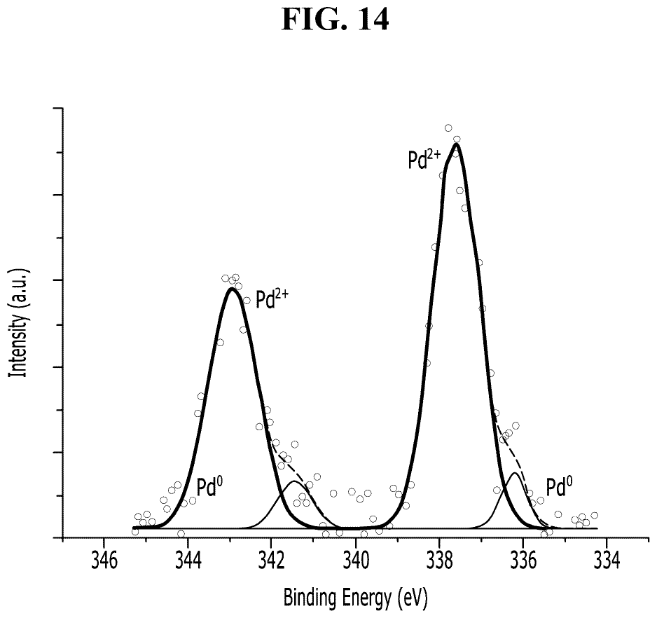

As shown in FIG. 11 and FIG. 14, it may be confirmed that most of Pt and Pd catalysts exist in a form of a single atom with a form of 2+ or 4+ and a small amount of a metal is present in the Pt and Pd catalysts.

### Experimental Example 3: Performance Test of Solid Oxide Cell

A three-layer electrolyte having a GDC-YSZ-GDC structure is manufactured on the fuel electrode manufactured in each of Embodiments 1 to 6 and Comparative Example 1. A first layer is deposited using PLD at a temperature of the fuel electrode of 700° C. in an O₂ atmosphere of 50 mTorr for 25 minutes using a GDC target. Thereafter, a second layer is manufactured to be deposited using PLD at a temperature of the fuel electrode of 700° C. in an O₂ atmosphere of 50 mTorr for 20 minutes using a YSZ target. A third layer is manufactured to be deposited using PLD at a temperature of the fuel electrode of 700° C. in an O₂ atmosphere of 50 mTorr for 5 minutes using a GDC target.

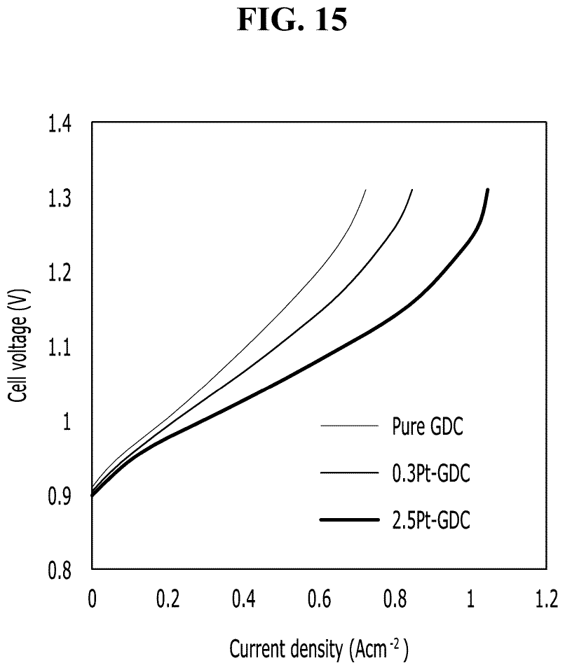

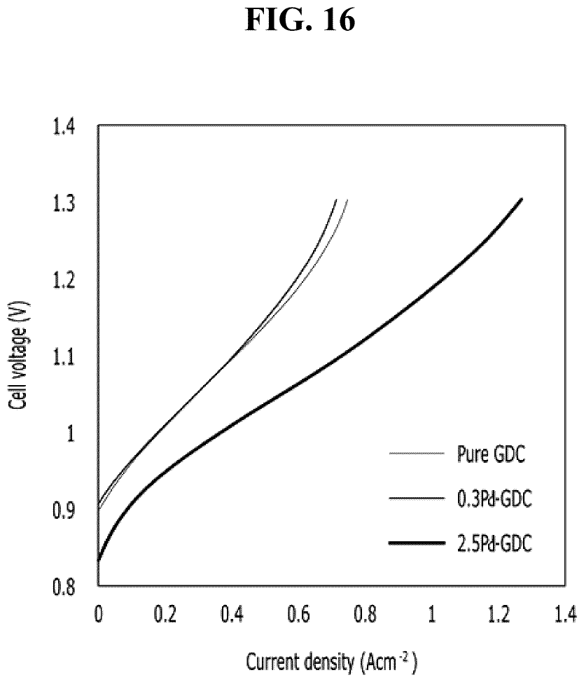

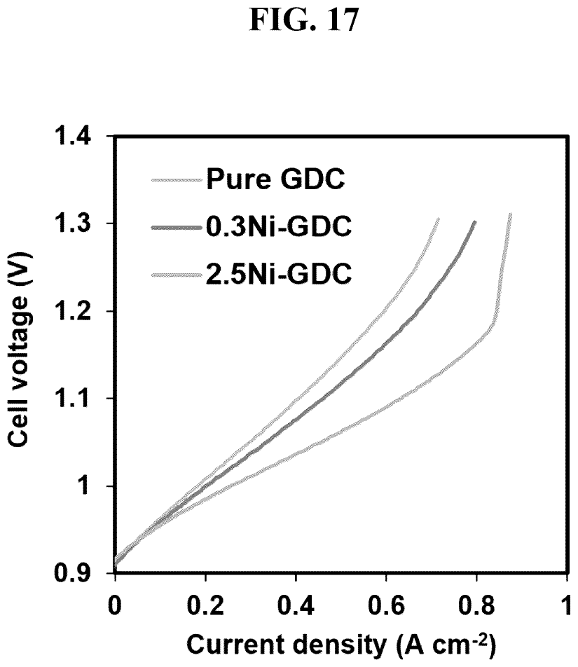

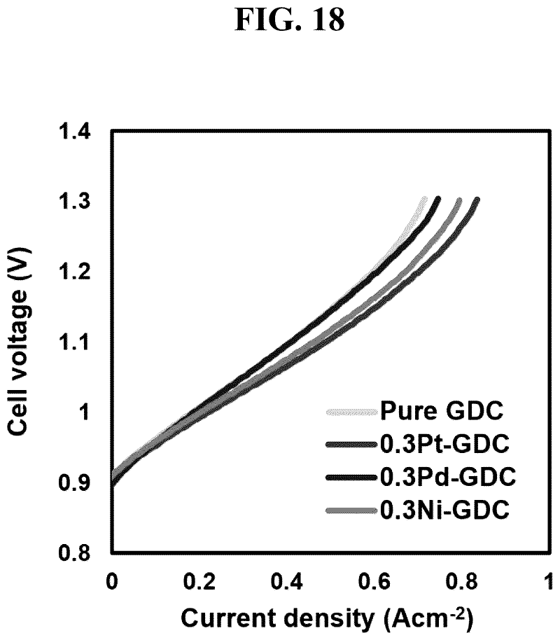

To manufacture the air electrode at the top, the air electrode is manufactured to be deposited using PLD at a temperature of the fuel electrode of 680° C. in an O₂ atmosphere of 300 mTorr for 2 hours using an LSC target. A test condition is conducted at a temperature of 650° C., a flow amount of 180 sccm of CO₂ for the fuel electrode, a flow amount of 20 sccm of CO for the fuel electrode, and a flow amount of 200 sccm for the air electrode, and a result of the test condition is shown in FIGS. 15 to 18.

As shown in FIGS. 15 to 18, it may be confirmed that performance of carbon dioxide conversion of the GDC electrode with each of Pt, Pd, and Ni is improved compared with that of the GDC electrode without the catalyst. In addition, it may be confirmed that a Pt catalyst among Pt, Pd, and Ni catalysts has best performance.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

<Description of symbols>

| | |
|---|---|
| 100: solid oxide cell for carbon | 10: fuel electrode |
| dioxide conversion | |
| 11: fuel electrode functional layer | 12: fuel electrode support layer |
| 20: electrolyte layer | 21: first GDC layer |
| 22: YSZ layer | 23: second GDC layer |
| 30: air electrode | |

What is claimed is:

1. A fuel electrode of a solid oxide cell for carbon dioxide conversion, comprising:
a fuel electrode support layer; and
a fuel electrode functional layer that is disposed on the fuel electrode support layer,
wherein the fuel electrode functional layer includes ceria doped with gadolinium in which at least one catalyst of Pt, Pd, and Ni is supported.

2. The fuel electrode of claim 1, wherein the catalyst is supported in an amount of 0.1 to 5.0 atom % within the fuel electrode functional layer.

3. The fuel electrode of claim 1, wherein the catalyst has an average particle diameter of 0.2 to 10 nm and is dispersed within the fuel electrode functional layer.

4. The fuel electrode of claim 1, wherein the gadolinium is included in an amount of 1 to 10 atom % within the fuel electrode functional layer.

5. The fuel electrode of claim 1, wherein the ceria is included in an amount of 85.0 to 98.9 atom % within the fuel electrode functional layer.

6. A manufacturing method for a fuel electrode of a solid oxide cell for carbon dioxide conversion, comprising:
mixing a catalyst powder including at least one of a Pt powder, a Pd powder, and a Ni powder with a ceria powder doped with gadolinium to manufacture a mixed powder;
manufacturing a molded body by compressing the mixed powder;
heat-treating the molded body; and
forming a fuel electrode functional layer on a fuel electrode support layer using the heat-treated molded body as a raw material.

7. The manufacturing method of claim 6, wherein in the manufacturing of the mixed powder, the catalyst powder is mixed in an amount of 0.1 to 5.0 atom % with respect to 100 atom % of the mixed powder.

8. The manufacturing method of claim 6, wherein a pressure applied to the mixed powder in the manufacturing of the molded body is 100 to 500 MPa.

9. The manufacturing method of claim 6, wherein in the heat-treating of the molded body, a temperature is increased at a temperature ramping rate of 50 to 150° C./h and heat treatment is performed at a temperature of 1000 to 1600° C.

10. A solid oxide cell for carbon dioxide conversion, comprising:
the fuel electrode described in claim 1 that includes the fuel electrode support layer and the fuel electrode functional layer;
an electrolyte layer that is disposed on the fuel electrode functional layer; and
an air electrode that is disposed on the electrolyte layer.
